(19) United States
(12) Patent Application Publication
(10) Pub. No.: US 2025/0047569 A1
(43) Pub. Date: Feb. 6, 2025

(54) METHOD FOR PREDICTING A VARIATION IN QUALITY OF SERVICE IN A V2X COMMUNICATION NETWORK, CORRESPONDING PREDICTION DEVICE AND CORRESPONDING COMPUTER PROGRAM

(71) Applicant: Orange, Issy-Les-Moulineaux (FR)

(72) Inventor: Maroua DRISSI, Chatillon Cedex (FR)

(21) Appl. No.: 18/718,164

(22) PCT Filed: Dec. 5, 2022
(86) PCT No.: PCT/EP2022/084337

§ 371 Date: Jun. 10, 2024

(30) Foreign Application Priority Data
Dec. 10, 2021 (FR) FR2113319

(51) Int. Cl. H04L 41/16; H04L 41/5009; H04W 24/06

(52) U.S. Cl. CPC H04L 41/16; H04L 41/5009; H04W 24/06

(57) ABSTRACT

A method for predicting a variation in the quality of service in a V2X communication network comprising at least one base station to which at least one user equipment is connected. The method includes: identifying at least one key performance indicator representative of the quality of service for the at least one user equipment, called a key performance indicator of interest; predicting, through deep learning based on past values of at least one secondary key performance indicator, the values being collected for the at least one base station, a future value of the at least one key performance indicator of interest; and transmitting, where applicable, a notification informing of the variation in quality of service to the at least one user equipment, based on the predicted value.

### CROSS-REFERENCE TO RELATED APPLICATIONS

This application is filed under 35 U.S.C. § 371 as the U.S. National Phase of Application No. PCT/EP2022/084337 entitled “METHOD FOR PREDICTING A VARIATION IN QUALITY OF SERVICE IN A V2X COMMUNICATION NETWORK, CORRESPONDING PREDICTION DEVICE AND CORRESPONDING COMPUTER PROGRAM” and filed Dec. 5, 2022, and which claims priority to FR 2113319 filed Dec. 10, 2021, each of which is incorporated by reference in its entirety.

### BACKGROUND

### Field

The field of the development is that of Vehicle-to-Everything communication (or V2X). More particularly, the development relates to the use of a quality of service (or QoS) prediction model for adaptation to a change in quality of service of user equipment in a network of V2X communication.

### Description of the Related Technology

Vehicle-to-Everything communication, or V2X, is the set of existing or future communication systems that allow vehicles to exchange information with external entities such as another vehicle, road infrastructure, pedestrians or a network of extended communication (for example Internet).

V2X communication is generally deployed on the basis of two technologies: Wi-Fi (for example according to the IEEE 802.11p standard), and the mobile telephone network (for example the 4G, or 5G network). In particular, V2X communication is deployed on the existing mobile network.

V2X communication comprises different types of communication:
communication called “V2V” communication for Vehicle-to-Vehicle: vehicles that support this type of communication can exchange messages (for example on their location, their speed, their condition, etc.). This exchange of messages takes place directly between vehicles or via a mobile telephone network infrastructure (for example a base station, within a cell). V2V communication allows a vehicle to alert other vehicles of a danger, a problem or simply to exchange information (speed, location, steering direction, braking or loss of stability etc.) so that the circulation is as smooth as possible. Vehicles can then act and take measures to avoid a problem during a sudden change of trajectory or emergency braking, for example;
communication called “V2I” communication for Vehicle-to-Infrastructure: vehicles that support this type of communication can exchange messages with the road infrastructure around them. These infrastructures can be traffic lights, lane markers, street lamps, parking meters, surveillance cameras, etc. V2I communication thus allows to collect and exchange data with road infrastructures in order to provide travelers and vehicles with real-time information on elements such as traffic conditions, traffic flow, accidents, work zones and availability of parking spaces. It is then possible to anticipate certain situations and act accordingly;
communication called “V2N” communication for Vehicle-to-Network allows, via mobile network infrastructures, to exchange data and establish communications between vehicles and a server for managing V2X applications for example. Vehicles can receive broadcast alerts about accidents further down the road or warnings of congestion or queues on the planned route for example;
communication called “V2P” communication for Vehicle-to-Pedestrian involves communications between a vehicle and a pedestrian or several pedestrians in the immediate vicinity. Furthermore, the communication may be aimed at other vulnerable road users, such as cyclists. V2P is achieved directly or through mobile network infrastructure. Different types of support help with V2P communication: smartphone, cane for the visually impaired, lighting, bicycle navigator, etc. This type of communication allows to warn the pedestrian of the approach of a vehicle, to warn the vehicle of the presence of vulnerable users, thanks to their location, and thus to guarantee their protection. It therefore allows to alert pedestrians and drivers of connected vehicles of potential dangers in the street.

Thus, V2X communication allows to ensure and improve road safety, reduce fuel consumption or else improve the experience between drivers and other road users, such as cyclists and pedestrians. In particular, V2X communication can be used in different ways, for example for cooperative driving, traffic jam warning, collision avoidance, danger warning, autonomous driving, driving assistance, infotainment.

The quality of service requirements related to each of these uses can be very different and have a significant impact on the telecommunication standards to be used to provide the appropriate service. Indeed, safe and efficient driving, particularly of automated vehicles, can be affected by sudden changes in the quality of service provided.

Current solutions proposed to deal with QoS changes cannot be applied to V2X communication. Indeed, these solutions are mainly based on manual modifications to the configuration of user equipment based on the observation over time of QoS variations (for example: manual increase in the capacity of certain base stations during periods when it is known that population density will increase). These solutions are not sufficiently dynamic. In particular, they do not allow sufficient time for the V2X application embedded in user equipment (for example connected vehicles, smartphones, etc.) to adapt smoothly and securely to variations in QoS.

There is therefore a need to improve the techniques for adapting to a change in QoS in a V2X type communication network context in order to ensure the safety of users or improve their experience. In particular, it is essential in the context of V2X communication to allow the V2X application of the user equipment to be informed in advance of a variation in QoS and to react to the latter with sufficient time in complete safety for the user.

### SUMMARY

The development responds to this need by proposing a method for predicting a variation in the quality of service in a V2X communication network comprising at least one base station, to which at least one user equipment is connected. The method comprises: identifying at least one key performance indicator (KPI) representative of the quality of service for said at least one user equipment, called key performance indicator of interest, predicting, through deep learning based on past values of at least one secondary key performance indicator, collected for said at least one base station, a future value of said at least one key performance indicator of interest, transmitting, where applicable, a notification informing of the variation in quality of service to said at least one user equipment, based on the predicted value.

Thus, the development is based on a completely new and inventive approach to predicting QoS variation in a V2X type communication network. More particularly, in order to satisfy the conditions of safety and quality of user experience of a network based on V2X type communication, the method according to the development implements a prediction of a variation in the quality of service (QOS). This QoS prediction allows in particular to anticipate variations in QoS and to warn, via sending an information notification, the user equipment of this variation. The equipment can then, upon receiving the notification, anticipate and adapt its behavior to the upcoming change.

Indeed, due to the variable conditions of the mobile network, it is not always possible to satisfy the quality of service requirements required by V2X applications. QoS prediction is then useful for user equipment in the V2X network to be informed in advance of any upcoming changes in the quality of service available, in order to allow V2X applications to take appropriate measures. These measures are, for example, the adaptation or complete shutdown of applications that cannot be operated safely under the planned quality of service conditions (for example: autonomous driving).

The deep learning step allows to accurately predict QoS variations.

According to a feature of the development, the prediction through deep learning also takes into account a distance measurement from said at least one user equipment to said at least one base station.

Advantageously, it is possible to refine the prediction of variation in the quality of service at the user equipment by taking into account the distance of the user equipment within the network coverage of a base station of this V2X communication network to which the equipment is connected. Indeed, it has been observed that the quality of service is different depending on the position of user equipment in the network coverage of the base station.

Thus, it is possible to predict a variation in QoS for the user equipment throughout a route.

According to another feature of the development, the method further comprises selecting, from a set of secondary key performance indicators, said at least one secondary key performance indicator taken into account for the prediction, a value of said at least one selected secondary key performance indicator influencing a value of the key performance indicator of interest.

Advantageously, the QoS prediction implements in particular a step of selecting a set of factors (also called secondary KPIs) for at least one key performance indicator (KPI) of interest to be monitored for a case of use of the V2X communication network (for example tele-operation). Indeed, different KPIs of interest must be monitored depending on the different use cases of V2X communication. The KPI(s) of interest depend on other secondary KPIs which will influence it. This selection of a relevant set of secondary KPIs, for a KPI of interest, allows to reduce prediction time and increase accuracy thereof. Indeed, in an environment as dynamic as a V2X communication network, this selection allows to eliminate secondary KPIs which would bias the QoS prediction.

Thus the combination of these specific QoS prediction steps allows to obtain a precise prediction and therefore to then warn the user equipment sufficiently in advance of the change in QoS.

According to a particular aspect of the development, the prediction through deep learning implements an LSTM type algorithm.

The implementation of an LSTM type algorithm is particularly advantageous for predicting QoS variation over time. Indeed, this type of algorithm allows to obtain precise temporal predictions, in particular by weighting the data collected by giving more importance to recent temporal data compared to older temporal data.

According to another particular aspect of the development, the LSTM type algorithm is implemented as a sliding window on said past values of said at least one selected secondary key performance indicator.

Thus, it is possible to optimize the performance of the prediction algorithm and obtain a more accurate prediction.

According to another feature of the development, the prediction is implemented based on past values of at least one secondary key performance indicator, collected for a plurality of base stations neighboring said network.

Using data from KPIs from several base stations, for example by integration at the operating subsystem (OSS), the speed and reliability of the prediction are thus increased by deep learning.

The development also relates to a device for predicting a variation in the quality of service in a V2X communication network comprising at least one base station to which at least one user equipment is connected. The prediction device is configured to: identify at least one key performance indicator (KPI) representative of the quality of service for said at least one user equipment, called key performance indicator of interest, predict, through deep learning based on past values of at least one secondary key performance indicator, collected for said at least one base station, a future value of said at least one key performance indicator of interest, transmit, where applicable, a notification informing of said variation in the quality of service to said at least one user equipment, based on said predicted value.

According to one feature of the development, the device is configured to predict the future value through deep learning also taking into account a distance measurement from said at least one user equipment to said at least one base station.

According to another feature of the development, the device is further configured to select, from a set of secondary key performance indicators, said at least one secondary key performance indicator taken into account for the prediction, a value of said at least one selected secondary key performance indicator influencing a value of said key performance indicator of interest.

According to another feature of the development, the prediction device is integrated into said at least one base station.

According to another feature of the development, the prediction device is integrated into network equipment configured to implement the prediction based on past values of at least one secondary key performance indicator, collected for a plurality of base stations neighboring the network.

Advantageously, when the prediction device is integrated into an operating subsystem (OSS), it is possible to collect KPI data (of interest or secondary) on a set of base stations located in a given geographical area. Thus, it is possible to predict a change in QoS on a route of user equipment, on which it successively connects to several base stations.

The development also relates to a computer program product comprising program code instructions for implementing a prediction method as described above, when executed by a processor.

The development also relates to user equipment connected to at least one base station of a V2X communication network. This equipment comprises: a communication module configured to receive, where applicable, a notification informing of a variation in the quality of service predicted according to a prediction method as described previously; a module for adapting processing carried out in the user equipment to the variation in the quality of service based on quality of service variation information comprised in said notification.

Advantageously, user equipment (such as an autonomous car) in a V2X communication network can anticipate the variation in QoS thanks to receiving a notification from a prediction device and relayed by a base station. In other words, the V2X application, via an adaptation module, reacts ahead of the QoS change upon receiving the information notification. Thus, when the QoS change takes place, the user equipment, thanks to the V2X application, has already adapted its behavior. Receiving a notification informing of variation in the quality of service before the actual change in QoS ensures the safety of users of a V2X communication network.

Furthermore, such a communication module is advantageously configured to transmit a distance measurement from the user equipment to the base station. It is thus possible to carry out a spatio-temporal prediction of the QoS variation for the user equipment.

The development also relates to a computer-readable recording medium on which is recorded a computer program comprising program code instructions for executing the steps of the method for predicting a variation in the quality of service in a V2X communication network according to the development as described above, when the program is executed by a processor.

Such a recording medium can be any entity or device capable of storing the program. For example, the medium may comprise a storage means, such as a ROM, for example a CD ROM or a microelectronic circuit ROM, or else a magnetic recording means, for example a mobile medium (memory card) or a hard drive or SSD.

On the other hand, such a recording medium may be a transmissible medium such as an electrical or optical signal, which may be conveyed via an electrical or optical cable, by radio or by other means, so that the program computer it contains can be executed remotely. The program according to the development can in particular be downloaded onto a network, for example the Internet network.

Alternatively, the recording medium may be an integrated circuit into which the program is incorporated, the circuit being adapted to execute the steps or to be used in the execution of the method for predicting a variation in the quality of service in a V2X communication network mentioned above.

According to an exemplary embodiment, the present technique is implemented by means of software and/or hardware components. With this in mind, the term “module” or “device” can correspond in this document to both a software component, a hardware component or a set of hardware and software components.

A software component corresponds to one or more computer programs, one or more subprograms of a program, or more generally to any element of a program or software capable of implementing a function or a set of functions, as described below for the concerned module. Such a software component is executed by a data processor of a physical entity (terminal, server, router, etc.) and is capable of accessing the hardware resources of this physical entity (memories, recording media, communication bus, electronic input/output cards, user interfaces, etc.). Subsequently, resources mean all sets of hardware and/or software elements medium of a function or service, whether unitary or combined.

In the same way, a hardware component corresponds to any element of a hardware assembly capable of implementing a function or a set of functions, according to what is described below for the concerned module. It may be a programmable hardware component or one with an integrated processor for executing software, for example an integrated circuit, a smart card, a memory card, an electronic card for executing firmware, etc.

Each component of the system previously described obviously implements its own software modules.

The different embodiments mentioned above can be combined with each other for the implementation of the present technique.

The prediction device and the corresponding computer program mentioned above have at least the same advantages as those conferred by the method for securing an exchange according to the present development.

### BRIEF DESCRIPTION OF THE DRAWINGS

Other purposes, features and advantages of the development will appear more clearly upon reading the following description, given as a simple illustrative and non-limiting example, in relation to the figures, among which:

FIG. 1 illustrates an example of an environment of a Vehicle-to-Everything communication network according to one embodiment of the development;

FIG. 2 illustrates the different steps of a method for predicting a variation in the quality of service in a V2X communication network according to one embodiment of the development;

FIG. 3A shows an example of a quality of service prediction step in a V2X communication network according to a first embodiment of the development;

FIG. 3B shows in graphical form the results of predicting the quality of service in a V2X communication network according to the embodiment of FIG. 3A;

FIG. 4A shows an example of an environment of a Vehicle-to-Everything communication network within network coverage of a base station according to one embodiment of the development;

FIG. 4B shows in graphic form the results of predicting the quality of service in a V2X communication network according to a second embodiment of the development;

FIG. 5 schematically illustrates an example of architecture of a device for predicting a variation in the quality of service in a V2X communication network, according to one embodiment of the development.

### DETAILED DESCRIPTION OF CERTAIN ILLUSTRATIVE EMBODIMENTS

The general principle of the development is based on the use of a spatio-temporal prediction model of the change in quality of service in a V2X communication network.

In particular, the development allows V2X communication applications embedded in user equipment (for example: autonomous vehicles, smart phone, connected watch, etc.) to be informed of a future QoS change and to react to it upstream.

Thus, the spatio-temporal prediction of QoS, for example along a specific route and/or in a specific period of time, allows to adjust the behavior of user equipment connected to the V2X network in terms of applications (for example: change at the vehicle automation, changing the vehicle speed, transferring to the driver, displaying an alert notification, etc.). It is thus possible to guarantee the safety of users of the V2X communication network, as well as the quality of the user experience.

For this purpose, QoS prediction helps provide early notifications about predicted QoS changes to interested consumers. This allows a V2X application (for example: vehicle tele-operation, infotainment, etc.), thanks to a module for adapting to QoS variations, to react before the planned QoS change takes effect. These prior notifications, when the predictions are sufficiently reliable, are then sent with a period of notice before the new predicted QoS is experienced. This notice period depends on the specific application and use case, but it should be long enough to give the application time to adapt to the future QoS.

An example of an environment of a “Vehicle-to-Everything” type communication network according to one embodiment of the development will now be presented in connection with FIG. 1.

This V2X communication network, or V2X network, comprises different user equipment: vehicles V (V₁, V_{1′}, V₂, V₃ or V₄) connected to the V2X network, road infrastructure I, smart phones or connected watches of pedestrians or cyclists P . . . and network equipment such as for example mobile network infrastructures N (base station or operating subsystem OSS).

Connected vehicles are for example autonomous vehicles, such as autonomous cars or trucks, or any type of vehicle, such as boats or planes. Connected vehicles can also be non-autonomous vehicles, but can still connect to the V2X network and exchange data with other user equipment or with a V2X application management server in a wide area network.

Thus, subsequently “user equipment” of a V2X communication network designates any equipment that can connect to the V2X network and exchange data (for example: autonomous car, smartphone, bicycle navigator, road infrastructure, etc.). The user equipment comprises in particular a communication module configured to transmit and receive data. In particular, via the communication module, user equipment is able to transmit its position to other equipment or to a base station, and receive notifications, in particular from the base station.

Road infrastructure I may be traffic lights, street lamps, traffic or display panels, etc.

This V2X communication network allows different specific types of communication, known for example as V2V (Vehicle-to-Vehicle), V2I (Vehicle-to-Infrastructure), V2N (Vehicle-to-Network) or V2P (Vehicle-to-Pedestrian). For this purpose, an infrastructure of relay antennas, or base stations N, allows, via the deployment of a mobile network, for example 5G, to relay these communications.

In one example, an autonomous vehicle V₁ can establish communication with another vehicle V_{1′} which is connected to the V2X network. This second vehicle V_{1′} may also be an autonomous vehicle or not. The autonomous vehicle V₁ can communicate with the connected vehicle V_{1′} in front of it, for example requesting a transfer of data from the camera on board V_{1′} to see if it can perform an overtaking maneuver. It is thus possible to improve the perception of the autonomous vehicle V₁ by benefiting from data collected (for example via a camera) by one or more other vehicles connected to the V2X network.

In another example, a connected vehicle V₂ (autonomous or not) can establish communication with a road infrastructure I, for example a traffic light, which then warns the vehicle V₂ of a change in light color.

In another example, a connected vehicle V₄ can communicate with a mobile network infrastructure, or base station N, either for access to the V2X communication network for communication with other network equipment, or for access with an extended WAN (for “Wide Area Network”) network for communication with a V2X application management server, for example for connection to the V2X autonomous driving service, or another V2X service. This V2X application management server SERV_V2X is for example located in the operator network and then manages one or more different V2X applications.

In another example, a connected vehicle V₃ can establish communication with a pedestrian, or cyclist, via V2P type communication. This technology differs from the three others presented by the fact that it establishes a link between a living being (the pedestrian) and an object (the vehicle). Communication between a connected vehicle and a pedestrian (or cyclist) is done for example via a connected watch, or smartphone, etc.

The different V2X applications each have specific quality of service requirements which depend on the performance of the mobile network. These requirements can be expressed in terms of key performance indicator or KPI such as: coverage, minimum required rate, acceptable packet loss rate, maximum allowable packet latency, etc. KPIs are mainly organized into six classes:
accessibility: it brings together the measures which allow operators to collect information relating to the accessibility of mobile services for the subscriber (for example the KPI used is the success rate representing the number of times where the user manages to connect to the service),
integrity: it measures the high or low quality of a service while the subscriber uses it (for example latency or data rate),
use: it measures the amount and quality of information circulating in the network,
retention: it measures the number of times a service has been interrupted or abandoned during use. Therefore, this prevents the subscriber from using the service and the operator cannot bill him (for example the KPI used is the number of times the user cannot connect to the service),
mobility: it measures the number of times a service was interrupted or abandoned during the transfer of a subscriber or his mobility from one base station to another,
energy efficiency (EE): measures the energy efficiency of the network modular data.

Depending on the case of usage or use, different KPIs must be taken into account. For example, if the use case is infotainment, only the data rate needs to be taken into account. On the contrary, if user safety is at stake, such as for example in the case of tele-operation, then several KPIs must be taken into account: data rate, latency and reliability. For these different use cases and KPIs, the required QoS may vary. Table 1 below shows examples of KPIs to take into account for different use cases and examples of reactions of the V2X application when the QoS of these KPIs is not respected.

TABLE 1

| | | Examples of potential reactions |
|---|---|---|
| | KPIs to be predicted | of the V2X application during |
| Use case | for the QoS change | a QoS change |
| Tele-operated | data rate, latency, | change route, park the vehicle, |
| driving | reliability | hand over to a nearby driver, |
| | | modify the set or properties of |
| | | the sensors, change the tele- |
| | | operation mode (for example, |
| | | switching from maneuvering to |
| | | providing a trajectory). |
| High density | latency, reliability | Change the inter-vehicle |
| vehicle grouping | | distance, hand over to the driver, |
| (or platooning) | | change the speed or length of the |
| | | platoon, end the platoon. |
| alert on | reliability | inform the user of the |
| dangerous areas | | availability of an alert service, |
| | | change the speed or the route. |
| lane merging | latency, reliability | change the speed of the merge |
| | | attempt, interrupt the lane merge |
| software update | data rate | reschedule, stop or resume |
| | | download |
| Infotainment | data rate | Change video quality, stop video |

Table 1 only shows examples of KPIs for certain use cases. It should be noted that this list is not exhaustive, and that other KPIs may be taken into account. Furthermore, the quality of service of a KPI (such as latency, or data rate) may be influenced by one or more other factors, also hereinafter referred to as secondary KPIs (for example: user density for a given base station, the quality of the mobile network etc.).

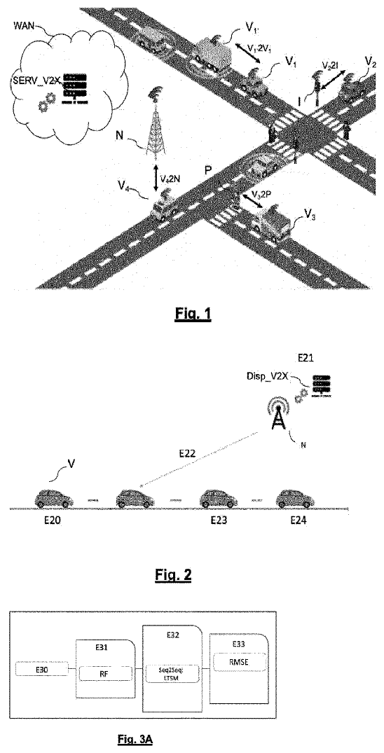

A diagram illustrating the different steps of a method for predicting a variation in the quality of service in a V2X communication according to one embodiment of the development will now be presented in connection with FIG. 2.

The case of a connected and automated vehicle V which is controlled remotely by a tele-operated driving application (or ToD) is described in this example. For the remote operation to be successful, the software application must be able to receive sufficient quality video data from the onboard cameras of the vehicle, as well as vehicle status data, such as speed and direction. At the same time, tele-operation controls must be transmitted with a latency of the order of 20 ms or less for example, because a greater delay can result in a lack of responsiveness. In such scenarios, the network must provide specific QoS to the tele-operation V2X application, particularly in terms of minimum data rate (uplink) and maximum latency (downlink).

In a step E20, the connected and automated vehicle V drives for example with a minimum data rate of 20 Mbps, and a minimum latency of the order of 20 ms.

In order to ensure user safety during tele-operation, it is essential to anticipate a possible change in quality of service, in particular for the previous KPIs: data rate and latency.

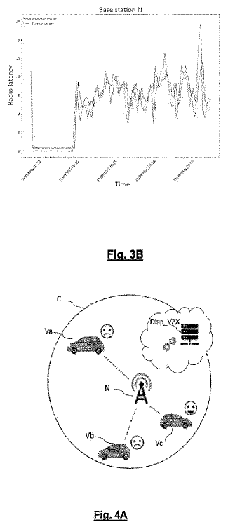

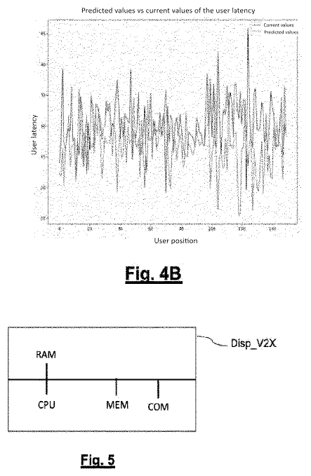

Thus, in a step E21, a QoS variation prediction device, Disp_V2X, implements a step of predicting a QoS variation by taking into account the different KPIs for the tele-operation use case. This QoS prediction step is presented below in connection with FIGS. 3A and 4A.

In other words, depending on the use case and the KPIs to be taken into account for the latter, the prediction device Disp_V2X makes a QoS prediction for each KPI to be monitored for the given use case.

The prediction device Disp_V2X can be located directly at a network infrastructure, such as the base station N.

Alternatively, this prediction device Disp_V2X can be located for example in a V2X application management server of the operator network, at the operating subsystem OSS. Advantageously, when the prediction device Disp_V2X is located in an operator management server SERV_V2X, the latter has access to data from several base stations.

During the prediction step E21, the prediction device Disp_V2X determines that depending on the trajectory that the vehicle V follows, in 20 seconds, the data download rate should fall below the threshold of 20 Mbps and the latency below the threshold 20 ms, for 30 seconds.

This change in situation wherein the mobile network is temporarily not able to ensure the agreed quality of service (that is to say download rate of 20 Mbps, latency of 20 ms) can still be managed correctly, provided that the V2X application of the vehicle V is informed in advance.

Thus, in a step E22, the prediction device Disp_V2X, via the base station N, informs the V2X application of the vehicle V of the non-compliance with the data download rate and the latency by transmitting a notification informing of the variation in QoS. In particular, this notification comprises the predicted values of KPIs of interest, such as latency and data rate. Furthermore, this notification may also comprise the duration during which the change in QoS takes place, that is to say the duration during which the KPI values are not respected. This notification can be sent for example via the 5G communication network, Wifi (“Wireless Fidelity”) or Lifi (“Light Fidelity”) . . . . Depending on the use case and the level of safety required, this notification is sent with sufficient notice to allow the application to make the necessary changes.

In a step E23, the V2X application embedded in the vehicle V takes an appropriate action/countermeasure, via an adaptation module. This allows the vehicle Y to slow down and adapt its speed to allow tele-operation to continue under future quality of service conditions. If the future quality of service is not at all sufficient for tele-operation, the reaction of the vehicle V can, in the worst case, bring the vehicle V to a controlled and safe stop.

In a step E24, the non-compliance with the data rate and latency then takes effect, but the necessary measures have already been taken by the V2X application of the vehicle V.

The example linked to FIG. 2 only presents an example of V2N type communication in the context of tele-operation. The prediction method presented above can be applied to all types of V2X communication previously presented. The method according to the development ensures user safety by anticipating future QoS changes and informing user equipment of this change before it occurs.

An example of a step of predicting the quality of service in a V2X communication network according to a first embodiment of the development will now be presented in connection with FIG. 3A.

As presented in connection with Table 1 above, one of the KPTs to take into account for the tele-operation use case is latency, that is to say the time necessary for the data packets to be transmitted from the V2X management server SERV_V2X to the base station N, or from the base station N to the connected and automated vehicle V.

In this first embodiment of the development, it is sought to make a temporal prediction of the QoS for a KPI, such as latency, at a base station.

This same temporal prediction model can be applied to any other relevant KPI in the context of tele-operation or other use cases.

In other words, for a use case, the temporal prediction of QoS is defined as the prediction over time of a change in QoS taking into account at least one KPI for a given base station or for a given user equipment. It should be noted that when the prediction device Disp_V2X is located in an operator management server, at the OSS, it is possible to predict the QoS for several base stations and therefore to effectively manage the situations of handover of user equipment during its movement.

Consider the case where the KPI of interest is the latency at the base station N. In a step E30, the prediction device Disp_V2X collects, via the base station, a set of secondary KPIs, or factors, which have a direct impact on latency at the base station N (for example: density of connected subscribers, quality of the mobile network, etc.). These secondary KPIs data are for example collected with a fine granularity of 15 min for the base station N. These data are then preprocessed to eliminate the zero values, for example according to standard statistical processing wherein the zero values are modified by the average or median of the values of the considered KPI.

In the presence of a very large data set, it is necessary to determine which data is truly informative for the prediction model. Indeed, due to the high dynamics of the environment, each base station in the network has different useful indicators (KPIs), for example depending on the density of users connected at different times of the day or season.

Thus, in a step E31, a phase of selection of secondary KPIs is applied. The objective of this phase is to reduce the number of secondary KPIs as input, in order to only process the most significant secondary KPIs, or the most relevant in the prediction of the future values of the KPI(s) of interest. Advantageously, this step allows to reduce the execution time of the prediction, but also to increase the precision of the prediction by removing non-significant secondary KPIs which may bias the prediction.

There are a number of feature selection techniques for estimating how informative the data is and, where applicable, eliminating those that are not relevant to the model. Here, use is preferentially made of a well-known algorithm for feature selection: “Random Forest” (RF).

From the previously filtered data, the prediction model then comprises a learning step E32. For this purpose, a “Sequence to Sequence” (or Seq2Seq) model is used. This learning model transforms one sequence into another sequence (sequence transformation). It does this using a recurrent neural network (or RNN). The first sequence contains the history of the values of secondary KPIs taken into account, that is to say selected in the previous step, which is transformed into an output sequence which goes from the current sample to the prediction horizon. The Seq2Seq algorithm is trained to match an input sequence of historical observations with an output sequence based on the prediction horizon. This process is repeated as a sliding window over the entire training data. The Seq2Seq model used in this prediction model is based on an LSTM (Long Short-Term Memory) algorithm. Advantageously, the use of an LSTM type learning algorithm allows to obtain precise predictions. This type of algorithm is particularly advantageous for dynamic environments, such as V2X communication. Another advantage of LSTM is that it assigns more importance to recent values in time compared to older values. In an example, it is known that the KPI values at 6 a.m. are different from those at 12 p.m., but that the KPI values at 11 a.m. are already closer to those at 12 p.m. Thus, when it is desired to predict the values of the KPIs at 12 p.m., the LTSM algorithm gives more importance to the KPIs values of 11 a.m., than to those of 6 a.m.

Once the prediction algorithm is trained, coefficients to be applied to new data to test the prediction are obtained.

In order to evaluate whether the model allows to accurately predict the change in QoS, predicted values are compared in a step E33 to the values of KPIs collected. For this purpose, the root mean squared error (or RMSE) is used as an evaluation measure.

As illustrated in connection with the graph FIG. 3B, the accuracy rate of the QoS temporal prediction model according to the development amounts to 79% accuracy for the latency at a given base station.

Thus, using the above model for temporal QoS prediction in a V2X communication network can accurately predict QoS changes over time. It is then possible to prevent, by sending a notification to user equipment, this change in QoS, sufficiently in advance to allow time for the V2X application to adapt.

In order to improve this temporal model for predicting a change in QoS and therefore increase the prediction accuracy, the position of the user equipment in the coverage of the base station is taken into account.

An example of an environment of a Vehicle-to-Everything communication network within network coverage of a base station according to one embodiment of the development is now presented in connection with FIG. 4A.

In this example, a base station N allows to create a V2X communication network (for example using a 5G telecommunication network), comprising the connected vehicles Va, Vb, Vc. The base station N allows the exchange of data between user equipment and a prediction device Disp_V2X, for example in a management server of the network operator at an operating subsystem (OSS).

The vehicles Va, Vb, and Vc are located at different positions in the network coverage C of the base station N. Thus, the vehicle Vc is the closest one and the vehicles Va and Vb the furthest. It was noted that even within the network coverage C of the same base station N, the precision of the data transmitted by the user equipment, here the vehicles Va, Vb and Vc (for example: position of the vehicles) is not the same, the same goes for latency at the user equipment. In other words, the information coming from the vehicle Vc, closer to the base station N, is more precise than that coming from the vehicles Va and Vb which are further away. In another example, the latency at the vehicle Vc is lower than that at the furthest vehicles Va and Vb.

Thus, the QoS within the network coverage of a base station is not the same depending on whether the user is more or less close to the latter.

Thus, in a second embodiment of the development, it is sought to make a spatio-temporal prediction of the QoS, taking into account the QoS at the base station N as presented in connection with FIG. 3A, and the distance of the user equipment to this base station N. In other words, it is sought to predict the QoS at the user level based on the QoS predicted temporally at the base station N and the distance of the user to this base station N.

In one example, it is sought to predict the latency at the user equipment, for example at the vehicles Va, Vb, Vc.

For this purpose, the prediction device Disp_V2X uses a linear regression model (for example according to the formulas below) using the temporal prediction data obtained in prediction step E21 of FIG. 2 according to the method described in connection with FIG. 3A, of one or more base stations in a given geographical area and the distance of the user equipment to these base stations on a chosen route:

$$x = ( \begin{matrix}{x}_{11} & … & {x}_{1 p} \\ ⋮ & ⋱ & ⋮ \\ {x}_{n 1} & … & {x}_{np}\end{matrix} ) y = ( \begin{matrix}{y}_{1} \\ ⋮ \\ {y}_{n}\end{matrix} )$$

where for p (p≥1) KPIs KPI₁, . . . , KPIₚ considered, for each of which n (n≥1) values are collected:
x₁₁ . . . xₙ₁ represent the n values collected from the first KPI₁,
. . . ,
x₁ₚ . . . xₙₚ represent the n collected values of the p-th KPIₚ considered.
y is a KPI of which n values y₁ to yₙ are to be predicted.

$${y}^{′} ( {x}_{i} ) = {β}_{0} + {β}_{1} {x}_{i 1} + {β}_{2} {x}_{i 2} + … + {β}_{p} {x}_{ip} , 1 \leq i \leq n ,$$

where y′ is the prediction of y, y′ being calculated using a linear regression function based on p+1 linear regression coefficients β₀, β₁, . . . , βₚ applied to an i-th value among n values collected for each of the p KPIs.

The results of predicting the quality of service in a V2X communication network according to this spatio-temporal QoS prediction model are presented in connection with FIG. 4B. These prediction results are representative of the comparison between the KPI “y” to be predicted and its prediction “y”. It can be seen that the combination of the temporal prediction of a change in QoS at a base station and the distance of the user from the base station allows to improve the accuracy of the prediction of a change in QoS at the user level. Indeed, the accuracy rate is 82% for user-level latency prediction.

Thus, spatio-temporal QoS change prediction allows connected vehicle users to request the predicted information from a specific base station, based on their routes.

In order to illustrate the principle of the development more precisely, FIG. 5 schematically presents the architecture of a prediction device Disp_V2X, according to one embodiment of the development.

The prediction device Disp_V2X comprises a RAM memory, a processing unit CPU equipped for example with a processor, and controlled by a computer program stored in a read only memory (for example a ROM memory or a hard disk). At initialization, the code instructions of the computer program are for example loaded into the RAM memory before being executed by the processor of the processing unit CPU.

The prediction device Disp_V2X further comprises a memory MEM allowing to store data from a V2X communication network, such as for example the identity of the connected equipment, the density of the equipment connected to the V2X network for each base station in a given geographic area . . . .

The prediction device Disp_V2X also comprises a communication module COM for receiving/transmitting data from V2X network user equipment via one or more base stations and transmitting QoS change notifications.

FIG. 5 illustrates only one particular way, among several possible, of creating the prediction device Disp_V2X, so that it carries out the steps of the method for predicting a variation in the quality of service in a V2X communication network detailed above, in relation to FIGS. 2 to 3A and 4A in its different embodiments. Indeed, these steps can be carried out indifferently on a reprogrammable calculation machine (a PC computer, a DSP processor or a microcontroller) executing a program comprising a sequence of instructions, or on a dedicated calculation machine (for example a set of logic gates like an FPGA or an ASIC, or any other hardware module).

In the case where the prediction device Disp_V2X is produced with a reprogrammable calculation machine, the corresponding program (that is to say the sequence of instructions) can be stored in a removable storage medium (such as for example an SD card, USB key, CD-ROM or DVD-ROM) or not, this storage medium being partially or totally readable by a computer or processor.

1. A method for predicting a variation in the quality of service in a V2X communication network comprising at least one base station, to which at least one user equipment is connected, wherein the method comprises:
identifying at least one key performance indicator representative of the quality of service for the at least one user equipment, called a key performance indicator of interest,
predicting through deep learning based on past values of at least one secondary key performance indicator, collected for the at least one base station, a future value of the at least one key performance indicator of interest, and
transmitting, where applicable, a notification informing of the variation in quality of service to the at least one user equipment, based on the predicted value.

2. The prediction method according to claim 1, wherein the prediction through deep learning also takes into account a distance measurement from the at least one user equipment to the at least one base station.

3. The prediction method according to claim 1, wherein the method further comprises selecting, from a set of secondary key performance indicators, the at least one secondary key performance indicator taken into account for the prediction, a value of the at least one selected secondary key performance indicator influencing a value of the key performance indicator of interest.

4. The prediction method according to claim 1, wherein the prediction through deep learning implements an LSTM type algorithm.

5. The prediction method according to claim 4, wherein the LSTM type algorithm is implemented as a sliding window on the past values of the at least one selected secondary key performance indicator.

6. The prediction method according to claim 1, wherein the prediction is implemented based on past values of at least one secondary key performance indicator, collected for a plurality of base stations neighboring the network.

7. A device for predicting a variation in the quality of service in a V2X communication network comprising at least one base station to which at least one user equipment is connected, wherein the device is configured to:
identify at least one key performance indicator representative of the quality of service for the at least one user equipment, called a key performance indicator of interest,
predict through deep learning based on past values of at least one secondary key performance indicator, collected for the at least one base station, a future value of the at least one key performance indicator of interest, and
transmit a notification informing of the variation in the quality of service to the at least one user equipment, based on the predicted value.

8. The prediction device according to claim 7, wherein the device is configured to predict the future value through deep learning also taking into account a distance measurement from the at least one user equipment to the at least one base station.

9. The prediction device according to claim 7, wherein the device is further configured to select, from a set of secondary key performance indicators, the at least one secondary key performance indicator taken into account for the prediction, a value of the at least one selected secondary key performance indicator influencing a value of the key performance indicator of interest.

10. The prediction device according to claim 7, wherein the device is integrated into the at least one base station.

11. The prediction device according to claim 7, wherein the device is integrated into equipment of the network configured to implement the prediction based on past values of at least one secondary key performance indicator, collected for a plurality of base stations neighboring the network.

12. A processing circuit comprising a processor and a memory, the memory storing program code instructions of a computer program to execute the method according to claim 1, when the computer program is executed by the processor.

13. A user equipment connected to at least one base station of a V2X communication network, wherein the user equipment comprises:
a communication module configured to receive a notification informing of a variation in the quality of service predicted according to a prediction method according to claim 1; and
a module for adapting processing carried out in the user equipment to the variation in the quality of service based on quality of service variation information comprised in the notification.

14. The user equipment according to claim 13, wherein the communication module is also configured to transmit a distance measurement from the at least one user equipment to the at least one base station.
